(19) United States
(12) Patent Application Publication
(10) Pub. No.: US 2016/0198046 A1
(43) Pub. Date: Jul. 7, 2016

(54) SKILL MANAGEMENT APPARATUS, METHOD AND PROGRAM

(71) Applicant: P&W Solutions Co., Ltd., Tokyo (JP)

(72) Inventor: Toshiyuki OMIYA, Tokyo (JP)

(21) Appl. No.: 14/981,511

(22) Filed: Dec. 28, 2015

(30) Foreign Application Priority Data
Jan. 7, 2015 (JP) 2015-001441

(51) Int. Cl. H04M 3/51; H04M 3/523; G06Q 10/06

(52) U.S. Cl. CPC H04M 3/5141; G06Q 10/063112; G06Q 10/063114; H04M 3/5233; H04M 3/5235

(57) ABSTRACT

To achieve early resolution of a busy state, by performing an appropriate skill change in accordance with the busy state. The queue assignment unit 14 assigns each of the plurality of operators to at least one of the plurality of queues, based on the skills and the skill levels. A busyness determination unit 17 determines whether a current state is a busy state having one or more busy queues in the plurality of queues, based on a preset criterion. When the current state is a busy state, a skill change unit 18 changes at least one of the skills and the skill levels of at least part of the plurality of operators, to a designated one.

This application is based on and claims the benefit of priority from Japanese Patent Application No. 2015-001441, filed on 7 Jan. 2015, the content of which is incorporated herein by reference.

### BACKGROUND OF THE INVENTION

1. Field of the Invention

The present invention relates to a skill management apparatus, method and program.

2. Related Art

Conventionally, in the art of switchboards (for example, refer to Patent Document 1), a plurality of queues are predefined by types, etc. of incoming calls. When there is an incoming call in relation to a predetermined queue, an operator having a skill in relation to the predetermined queue responds to the call.

Patent Document 1: Japanese Unexamined Patent Application, Publication No. 2008-219350

### SUMMARY OF THE INVENTION

However, when the switchboard receives a larger-than-expected number of calls in relation to a particular queue (skill), exceeding the capacity of a plurality of operators assigned, it may take a long time for the operators to answer the calls.

In such a case, as a measure which has been conventionally taken, the skills of the operators for responding to queues in relation to other skills are changed to the skill in relation to this particular queue, and the operators are instructed to respond to this particular queue. This type of operation of changing the skills that can be provided by operators is hereinafter referred as a “skill change”. As described later, the skill change includes changing the skill level within the same skill.

In the conventional skill change methods, operators targeted for a skill change are determined in advance; an administrator or the like evaluates the busy state by way of visual observation or the like, and manually executes a skill change (by manually inputting a skill change command for individual operators).

Therefore, in many cases, a skill change has not been performed in an appropriate way to cope with a busy state.

The present invention has been made in view of the aforementioned situation, aiming to achieve early resolution of a busy state, by performing an appropriate skill change in accordance with the busy state.

In order to achieve the above-mentioned object, a skill management apparatus according to one aspect of the present invention includes:

a queue management unit that manages a plurality of queues, each of which is associated with a predetermined single skill;

an operator management unit that manages one or more skills and skill levels of each of the one or more skills, for each of a plurality of operators who can provide the skills;

a queue assignment unit that assigns each of the plurality of operators to at least one of the plurality of queues, based on the skills and the skill levels;

a busyness determination unit that determines whether a current state is a busy state having one or more busy queues in the plurality of queues, based on a preset criterion; and

a skill change unit that changes at least one of the skills and the skill levels of at least part of the plurality of operators, to a designated one, when the current state is the busy state.

Here, the skill change unit can change at least one of the skills and the skill levels of a designated number of operators to be changed, in relation to the plurality of operators.

The number of operators to be changed can be set, based on the skill levels of the plurality of operators.

The skill change unit can change the skills of the operators, who can provide multiple skills, to a designated single skill, in relation to the plurality of operators.

In a case in which the busy state is resolved, the skill change unit can restore a pre-change state of the skills or the skill levels of the operators, which were changed when determining the busy state.

A busy queue determination unit can further determine the busy state at a plurality of grades; and

the skill change unit can change a method for changing at least one of the skills and skill levels, in accordance with the plurality of grades.

In a case in which a predetermined grade of the busy state is resolved, the skill change unit can restore a pre-change state of the skills or the skill levels of the operators, which were changed when determining the predetermined grade.

In order to achieve the above-mentioned object, a skill management method and program according to one aspect of the present invention are a method and program corresponding to the skill management apparatus according to the one aspect of the present invention, as described above.

According to the present invention, it is possible to achieve early resolution of a busy state, by performing an appropriate skill change in accordance with the busy state.

### BRIEF DESCRIPTION OF THE DRAWINGS

FIG. 1 is a schematic diagram showing functional blocks of a skill management apparatus according to an example of a preferred embodiment of the present invention;

FIG. 2 is a diagram showing an example of a screen for setting the use of skill change functions;

FIG. 3 is a diagram showing an example of a screen for setting a skill change method;

FIG. 4 is a diagram showing an example of a screen for setting the skill change method;

FIG. 5 is a diagram showing an example of a screen for setting the skill change method;

FIG. 6 is a diagram showing a specific example of the skill change for operators who can provide multiple skills;

FIG. 7 is a diagram showing a specific example of the skill change for operators who can provide multiple skills;

FIG. 8 is a diagram showing an example of a screen for setting automatic escalation;

FIG. 9 is a diagram showing an example of a screen, which is displayed when an edit is instructed by way of an operation on the screen of FIG. 8; and

FIG. 10 is a flowchart illustrating flow of skill change processing, which is executed by a skill management apparatus 1 having the functional configuration of FIG. 1.

### DETAILED DESCRIPTION OF THE INVENTION

An embodiment of the present invention is hereinafter described with reference to the drawings, based on examples.

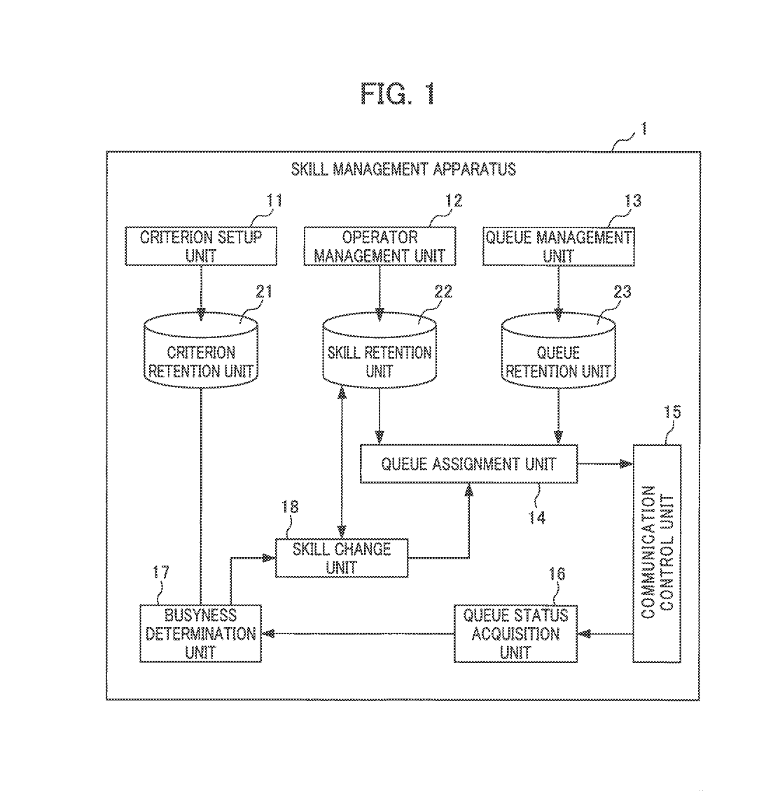

FIG. 1 is a schematic diagram showing functional blocks of a skill management apparatus according to an example of a preferred embodiment of the present invention.

A skill management apparatus 1 is configured to include a criterion setup unit 11, an operator management unit 12, a queue management unit 13, a queue assignment unit 14, a communication control unit 15, a queue status acquisition unit 16, a busyness determination unit 17, and a skill change unit 18.

The term “include” is used herein, since there could be functional blocks having other functions.

Namely, these units (the criterion setup unit 11 to the skill change unit 18) are composed of a central processing unit (CPU) that computes and processes information. In other words, the central processing unit controls the entirety of the skill management apparatus 1, and has these units (the criterion setup unit 11 to the skill change unit 18) in order to achieve some of the functions thereof.

The central processing unit reads and executes various programs stored in a storage unit (not shown) as appropriate, thereby collaborating with the aforementioned hardware, and realizing various functions according to the present invention. Namely, in the present embodiment, these units (the criterion setup unit 11 to the skill change unit 18) are realized by a combination of hardware such as CPU, etc. with software.

The storage unit (not shown) may include: local memory to be used for the execution of programs in combination with the central processing unit; large-capacity bulk memory; and cache memory to be used for efficiently searching the bulk memory. The storage unit stores various programs to be executed. A computer-readable medium (storage medium) for realizing the storage unit may include a medium, which is realized in an electrical, magnetic, optical, or electromagnetic manner. More specifically, such a medium includes semiconductor memory, magnetic tapes, magnetic disks, random access memory (RAM), read-only memory (ROM), and optical disks including CD-ROM, CD-R/W and DVD.

In an area of such a storage unit (not shown), a criterion retention unit 21, a skill retention unit 22 and a queue retention unit 23 are provided.

The skill management apparatus 1 includes an input unit and an output unit (not shown).

The input unit is intended to receive an input from an administrator or the like, and may include a keyboard, a pointing device, etc.

The output unit displays a screen for receiving a data input from an administrator or the like, and displays a screen of an arithmetic processing result of the central processing unit. The output unit includes a display unit such as a cathode ray tube display device (CRT) and a liquid crystal display device (LCD).

The criterion setup unit 11 sets a criterion for determining whether each queue is busy (hereinafter referred to as “busy queue criterion”). A queue, which is currently determined to be busy, is hereinafter referred to as “busy queue”.

The present embodiment employs, but should not be limited in particular to, the following busy queue criteria (A) to (C). The following criteria (A) to (C) can be used in arbitrary number and combination:

(A) the waiting time having exceeded a certain period of time (threshold value);

(B) the number of waiting calls having exceeded a certain number (threshold value); and

(C) the service level having fallen below a constant level (for example, no longer capable of responding to a certain percentage of incoming calls within certain seconds).

As described later, a plurality of grades of the busy state can be set (as a state having one or more busy queues). A threshold value to be used and how to resolve the busy state can be set at each grade.

In this manner, the busy queue criteria, which have been set by the criterion setup unit 11, are retained by the criterion retention unit 21.

The operator management unit 12 manages one or more skills and skill levels of each of the skills, for each of a plurality of operators who can provide the skills.

The skill retention unit 22 retains the one or more skills and the skill levels of each of the skills that can be provided by each of the plurality of operators.

Here, even if there are calls relating to the same type of skill, there may be cases in which only the operators having a skill at a certain level or higher can respond to some of the calls. Namely, an operator who can respond to a certain call varies, depending on not only the skill (queue) but also the skill level.

The queue management unit 13 manages a plurality of queues, each of which is associated with a predetermined single skill. The queue retention unit 23 retains information of a plurality of queues to be managed (skills that can be provided).

The queue assignment unit 14 assigns each of the plurality of operators to at least one of the plurality of queues, based on the skills and the skill levels.

The phrase “at least one” is used herein, since there may be an operator(s) who can provide a plurality of skills (multiple skills). Namely, an operator, who can provide multiple skills, can also respond to a call relating to a predetermined skill (predetermined queue) and subsequently respond to another call (another queue) relating to another skill.

The communication control unit 15 executes control to transmit a result of assignment by the queue assignment unit 14 to another device (not shown) such as a terminal of each operator.

The communication control unit 15 executes control to receive information, which shows various states of a plurality of queues, respectively (various states as used in the busy queue criteria), from another device (not shown).

The queue status acquisition unit 16 acquires the various states of the plurality of queues, respectively (various states as used in the busy queue criteria), based on the information received from another device in this manner.

For example, in the case of employing the busy queue criterion “(A) the waiting time having exceeded a certain period of time (threshold value)”, the queue status acquisition unit 16 acquires the waiting time of each of the plurality of queues.

The busyness determination unit 17 determines whether the current state is a busy state, based on the busy queue criterion. It should be noted that the busy queue criteria are assumed to be set in advance by the criterion setup unit 11, and are retained in advance by the criterion retention unit 21, as described above.

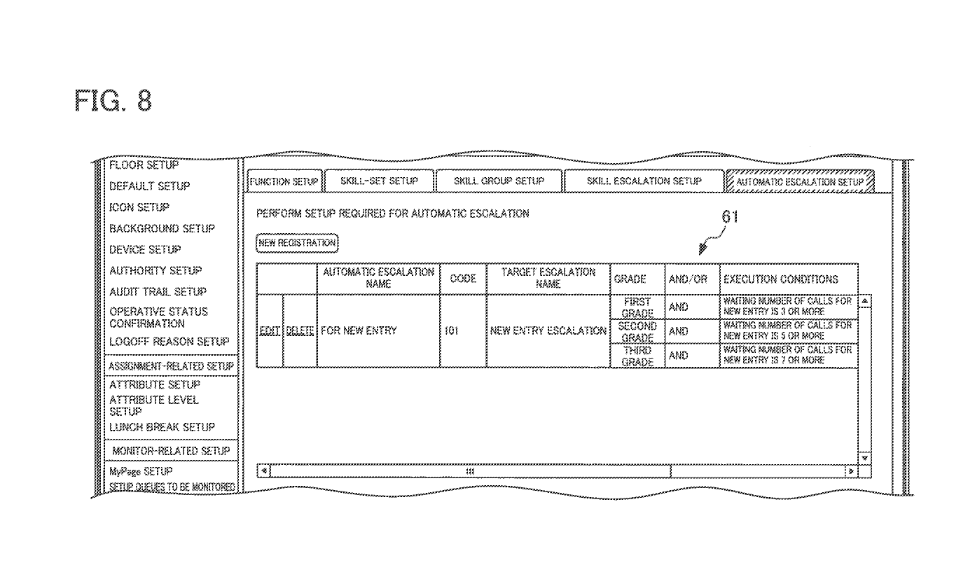

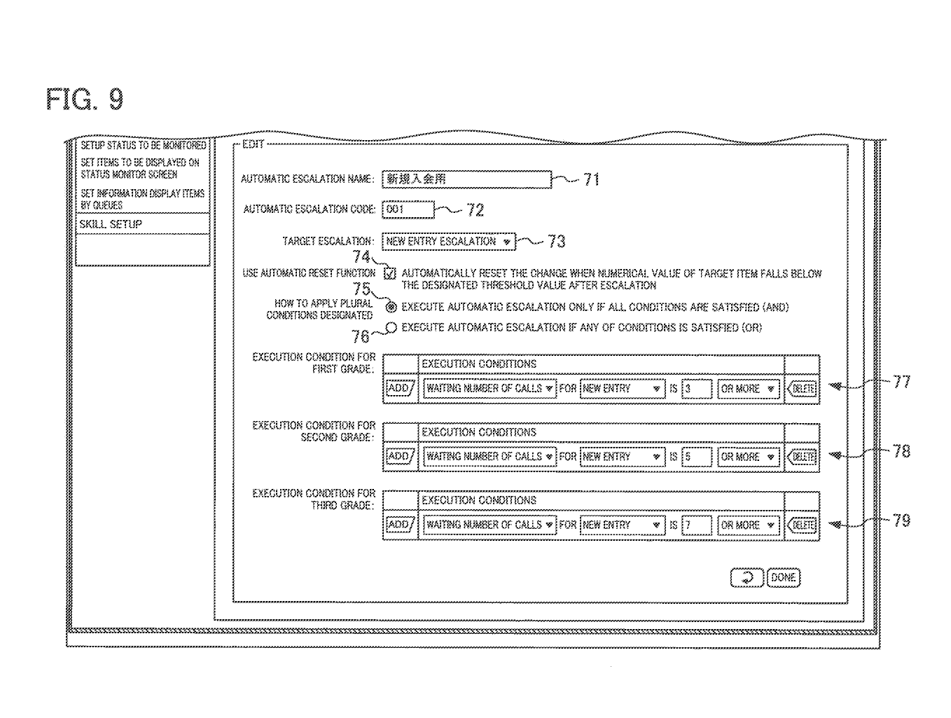

Here, the busy state refers to a state having one or more busy queues in a plurality of queues, and refers to a state that can be arbitrarily defined by each administrator or the like. Namely, the administrator or the like can also create an algorithm for determining a busy state (defining a criterion), by setting one or more busy queue criteria, and appropriately combining the one or more busy queue criteria. Provided, however, a specific method for defining a busy state will be described later with reference to FIGS. 8 and 9.

When the current state is a busy state, the skill change unit 18 changes at least one of the skills and skill levels of at least part of the plurality of operators, to a designated one. Namely, the skill change unit 18 performs a skill change.

Here, the post-change skill may often be a busy skill (queue) in general, but is not limited to a busy skill (queue), in particular. This is because, since the purpose herein is to resolve the busy state at the entire call center, if the busy state is expected to be resolved by changing the skill to an other skill (queue), the other skill (queue) can serve as a post-change skill.

Meanwhile, when the busy state is resolved, the skill change unit 18 restores the skills and skill levels of the operators, which were changed by the skill change

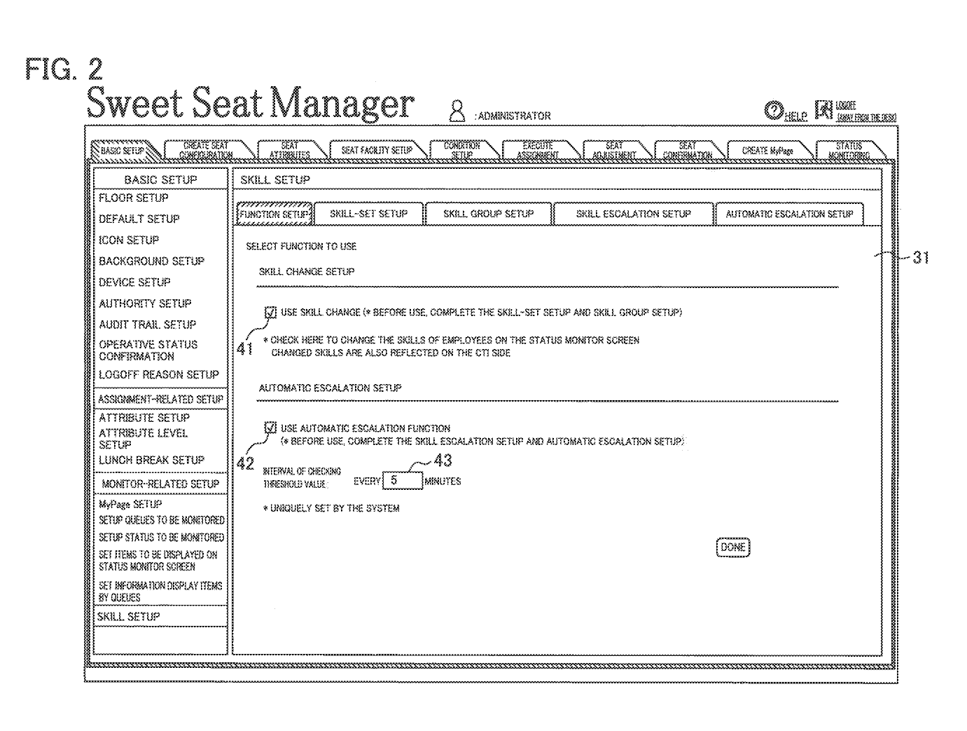

Next, with reference to FIGS. 2 to 9, a technique of setting a skill change is described.

FIG. 2 is an example of a screen for setting the use of skill change functions.

On a screen 31 of FIG. 2, the administrator or the like can set whether the skill change function is used. Specifically, in the case of using the function, the administrator or the like checks a check box 41.

The administrator or the like can set whether an automatic escalation function is used. Specifically, in the case of using the function, the administrator or the like checks a check box 42.

The automatic escalation refers to an (automatic) operation by the skill management apparatus 1 to sequentially perform the skill change in accordance with each grade of the busy state, based on the autonomous determination. Namely, the automatic escalation may be used when the administrator or the like wishes to manage the busy state at multiple grades.

The automatic escalation determines whether a skill change can be performed, based on a result of determination by the busyness determination unit 17, as described above. A time interval of the determination process by the busyness determination unit 17 (time interval of checking with a threshold value defined as the busy queue criterion) is set by inputting a value in a box 43. For example, in the example of FIG. 2, since “5” is input into the box 43, a determination process by the busyness determination unit 17 is repeated every five minutes, to determine whether a skill change is performed, based on a result of the determination process.

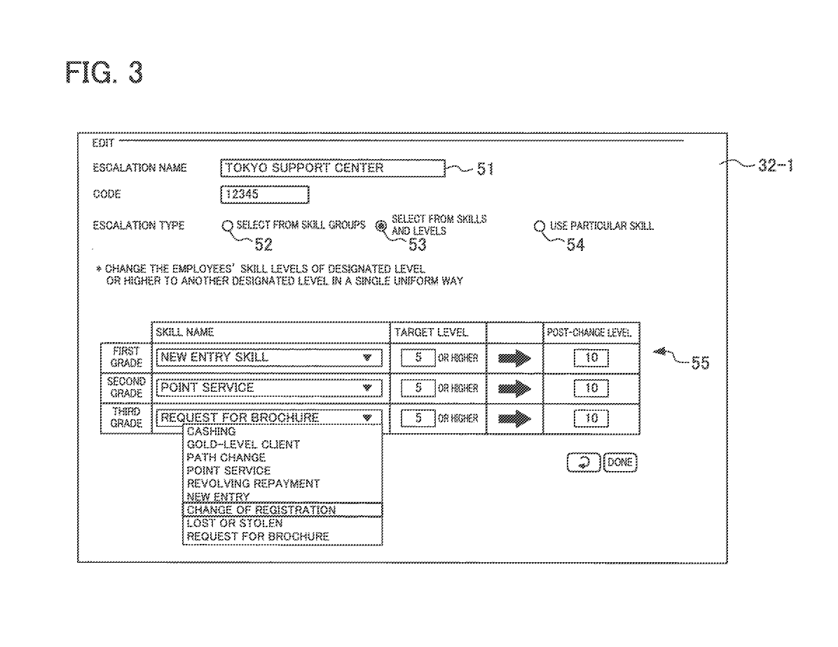

FIGS. 3 to 5 show an example of a screen for setting a skill change method.

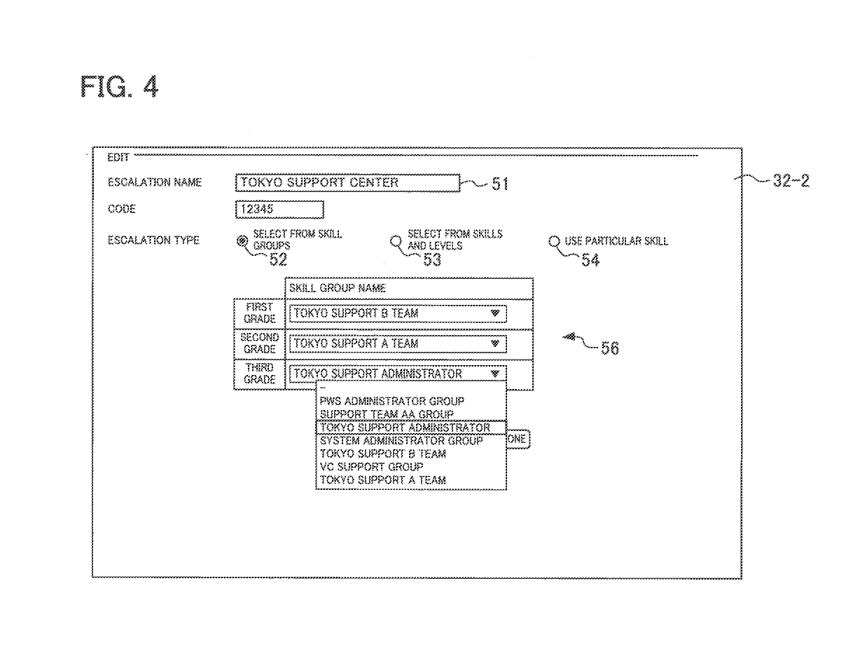

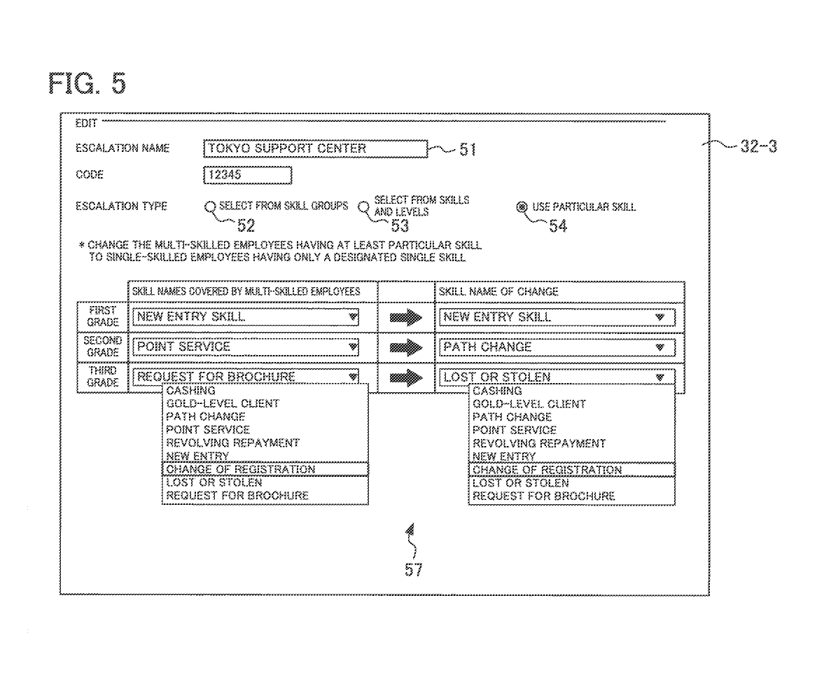

Namely, the administrator or the like can set a skill change method, by using a screen 32-1 of FIG. 3, a screen 32-2 of FIG. 4, or a screen 32-3 of FIG. 5.

First of all, the administrator or the like inputs an escalation name into a box 51.

Next, the administrator or the like sets one type desired from among three types (escalation types) of the skill change method.

Specifically, for example, in a case in which a type of the skill change method to “select from skills and levels” is desired, the administrator or the like checks a selection box 53. As a result, the screen 32-1 of FIG. 3 is displayed.

Here, to “select from skills and levels” is a skill change method, in which a “skill name” of a certain skill is selected, and the skill levels of the operators having a skill level at the “target level” or higher are changed in a single uniform way to a “post-change level”.

Here, even if there are calls relating to the same type of skill, there may be cases in which only the operators having a skill at a certain level or higher can respond to some of the calls. Accordingly, by setting to “select from skills and levels”, when the state is a busy state, the operators at levels lower than a predetermined skill level (but at the target level or higher) are temporarily changed to this predetermined skill level, and can be temporarily able to respond to such calls. As a result, the busy state is resolved.

In the present embodiment, as shown in FIGS. 8 and 9 to be described later, a busy state can be set at multiple grades; and three grades (first to third grades) are set in this particular example.

Therefore, the administrator or the like inputs or selects a skill name, a target level, and a post-change level, for each of the first to third grades, in an input area 55, thereby setting to “select from skills and levels”.

For example, in the illustrative setup in FIG. 3, when the busy state is at the first grade, the operators at a skill level “5” or higher are targeted for the skill change, and their skill level of the “new entry skill” is changed in a single uniform way to “10”. As a result, the temporarily increased number of operators can respond to the calls, to which only the operators having the “new entry skill” at the skill level “10” or higher were able to respond; therefore, the busy state can be resolved.

Further, for example, in a case in which a type of skill change method to “select from skill groups” is desired, the administrator or the like checks a selection box 52. As a result, the screen 32-2 of FIG. 4 is displayed.

Here, to “select from skill groups” is a skill change method, in which a “skill group name” of a certain group is selected, and the skill levels of operators belonging to the group are changed in a single uniform way.

Namely, by setting to “select from skill groups”, when the current state is a busy state, the skills of all of the operators belonging to the group of the “skill group name” are changed to a predetermined skill (for example, a predetermined busy skill) which can resolve the busy state. The number of operators having a predetermined skill can be temporarily increased in this manner; therefore, the busy state can be resolved.

The administrator or the like selects a skill group name for each of the first to third grades, in an input area 56, thereby setting to “select from skill groups”.

For example, in the illustrative setup in FIG. 4, when the busy state is at the first grade (refer to FIGS. 8 and 9 to be described later), the skills of all of the operators belonging to “Tokyo Support B Team” are changed in a single uniform way to a predetermined skill (for example, the “new entry skill” required for responding to the busy queue). As a result, a temporarily increased number of operators can provide a predetermined skill; therefore, the busy state can be resolved.

As described above, in the example of FIG. 3, the skills of the operators having a skill level at the “target level” or higher are changed in a single uniform way. In the example of FIG. 4, all of the operators belonging to the group of the “skill group name” are changed in a single uniform way.

In other words, both of the examples of FIGS. 3 and 4 can be understood such that it is not only specific individual operators but the “number of operators to be changed” who are set as the target for the skill change. Namely, in the example of FIG. 3, the number of operators at the “target level” or higher is set as the “number of operators to be changed”. Further, in the example of FIG. 4, the number of operators in the group of the “skill group name” is set as the “number of operators to be changed”.

Namely, the “number of operators to be changed” as used herein signifies a wide concept, which includes not only a certain fixed number of operators, but also the number of operators that can be changed depending on the situation.

In this manner, as the skill change method, it is possible to employ a method of setting the “number of operators to be changed”, who are targeted for the skill change. In relation to such a method, the examples of FIGS. 3 and 4 show the cases in which the “number of operators to be changed” is variable. Meanwhile, although not illustrated, it is also possible to employ a method of setting a fixed number of operators, such as “five”, for example, as the number of operators to be changed.

An index for setting the “number of operators to be changed” is the skill levels of the operators in the example of FIG. 3, and the skill groups of the operators in the example of FIG. 4. However, these are merely an example, and are not limited thereto in particular.

In this manner, in the present embodiment, it is not individual operators but the “number of operators to be changed” who are set as the target for the skill change. This is because a specific operator may not be at his/her office on that day.

In other words, a skill change cannot be realized if specific operators are individually set. In contrast, as in the case of the present embodiment, if the “number of operators to be changed” is set, it is possible to perform a skill change for just the “number of operators to be changed”, in relation to the operators being at the office on that day.

Further, in the present embodiment, in addition to such a method of setting the “number of operators to be changed” (examples of FIGS. 3 and 4), a method to “use a particular skill” is also employed, as the skill change method.

Namely, in a case in which a type of skill change method to “use a particular skill” is desired, the administrator or the like checks a selection box 54. As a result, the screen 32-3 of FIG. 5 is displayed.

Here, to “use a particular skill” refers to a skill change method, in which the skills of the operators who can provide multiple skills including a skill (hereinafter referred to as a “particular skill”) in “skill names covered by multi-skilled employees” are changed to a skill designated in the “skill name of change” (hereinafter referred to as a “post-change skill”).

As a result, the multi-skilled operators can concentrate on providing the post-change skill. Namely, for the multi-skilled operators, providing a post-change skill alone is less complexed than providing the multiple skills. As a result, the efficiency at the entire call center can be improved; therefore, the busy state can be resolved.

Namely, since the factor for resolving the busy state is resolving the complexity for the multi-skilled operators, a particular skill does not always need to coincide with a post-change skill. Namely, if the particular skill is a busy skill, the post-change skill is also a busy skill, in general. However, as long as the busy state at the entire call center can be resolved by the multi-skilled operators achieving maximum performance with the post-change skill, the particular skill and the post-change skill may be set as different skills, depending on the situation.

The administrator or the like sets to “use a particular skill” by selecting, in an input area 57, a skill name (particular skill) covered by multi-skilled employees, and a skill name of change (post-change skill), for each of the first to third grades of the busy state (refer to FIGS. 8 and 9 to be described later).

For example, in the illustrative setup in FIG. 5, when the busy state is at the first grade, the skills, which can be provided by the operators who can provide multiple skills including the “new entry skill”, are changed in a single uniform way to a single skill of the “new entry skill”. As a result, the multi-skilled operators can concentrate on providing the “new entry skill”; therefore, the busy state can be resolved.

As described above, in the skill change method illustrated in the example of FIG. 5, in relation to the plurality of operators, the skills of the operators who can provide multiple skills are changed to a designated single skill.

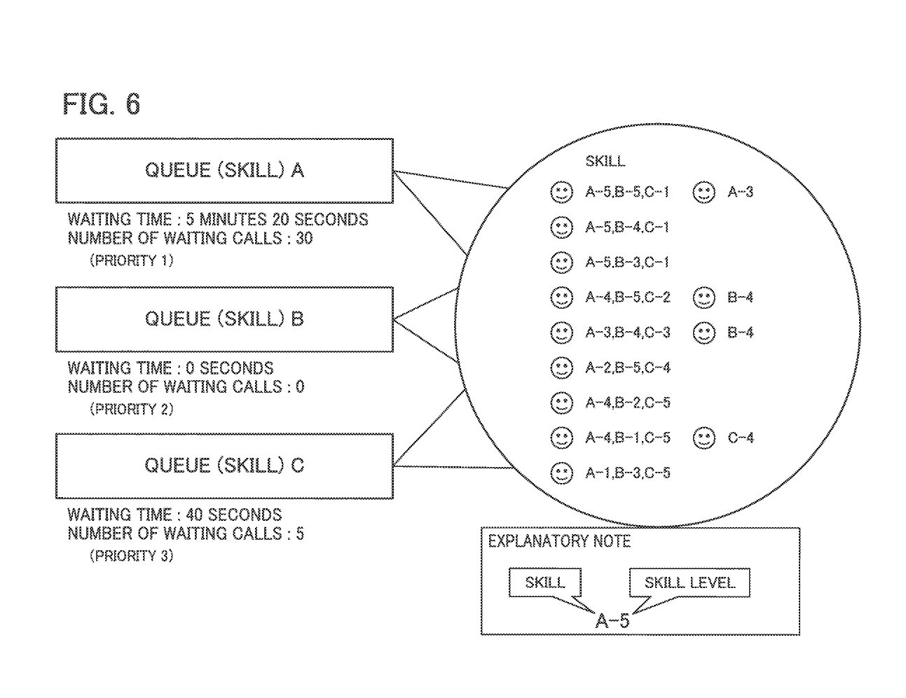

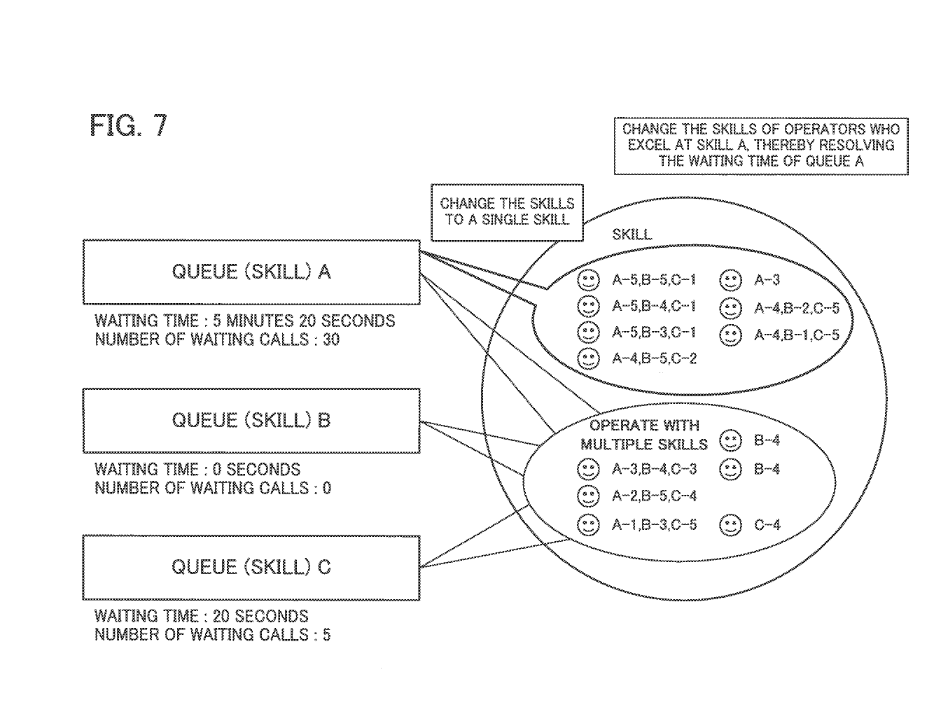

With reference to FIGS. 6 and 7, a specific example of the skill change targeted for the operators who can provide multiple skills is described.

As shown in FIG. 6, assume that three queue (skills) A to C exist.

Assume that a queue (skill) A has priority 1, in which the waiting time is 5 minutes 20 seconds, and the number of waiting calls is 30. Assume that a queue (skill) B has priority 2, in which the waiting time is 0 seconds, and the number of waiting calls is 0. Assume that a queue (skill) C has priority 3, in which the waiting time is 40 seconds, and the number of waiting calls is 5.

In FIG. 6, a human face symbol represents an operator; and a pair of alphabet and number on the right side of the symbol represents “(skill that can be provided)-(skill level of the skill)” (refer to the explanatory note in FIG. 6).

For example, the operator at the upper left corner can provide three skills A, B and C, in which the skill level of skill A is 5, the skill level of skill B is 5, and the skill level of skill C is 1.

On the other hand, the operator at the upper right corner can provide only skill A, in which the skill level of skill A is 3.

In this example, as shown in FIG. 7, since the queue (skill) A is a busy queue, in relation to the operators who can provide multiple skills, the skill change unit 18 (FIG. 1) changes the skills of the operators, who excel at skill A, to only skill A (single skill).

This resolves the waiting time of the queue A; and as a result, the busy state at the entire call center is resolved.

On the screen 32-3 illustrated in FIG. 5, only the skill names (particular skills) covered by the multi-skilled employees can be set as a condition for extracting the operators targeted for the skill change; however, not only a particular skill but also a skill level of the particular skill can be set; namely, in the example of FIGS. 6 and 7, skill A is set as a particular skill, and the skill level is set at “4 or higher”.

Referring now to FIGS. 8 and 9, automatic escalation (multilevel setup of skill change) is described.

FIG. 8 shows an example of a screen for setting automatic escalation. FIG. 9 shows an example of a screen, which is displayed when an edit is instructed by way of an operation on the screen of FIG. 8.

Namely, a display area 61 of FIG. 8 shows the setup of automatic escalation; and when “edit” in the display area 61 is selected by way of a click or the like, the screen of FIG. 9 is displayed.

First of all, the administrator or the like sets an automatic escalation name in a box 71, an automatic escalation code in a box 72, and a targeted escalation in a box 73.

Whether an automatic reset function is used can be set by checking a check box 74.

Here, the automatic reset function refers to a function of automatically resetting the skill change (restoring the state of each operator to the original state), when the busy state is resolved by performing the escalation (a multilevel skill change) (precisely, when each grade of the busy state is sequentially resolved), after the busy state occurred. The case of resolving each grade of the busy state refers to a case where a numerical value of a target item of each grade, which is input in input areas 77 to 79 to be described later, falls below a threshold value.

Namely, when the check box 74 is checked, upon resolving the busy state, the skill change unit 18 (FIG. 1) restores the pre-change state of the skills or the skill levels of the operators, which were changed when determining the busy state. Here, the busyness determination unit 17 (FIG. 1) determines whether the busy state is resolved, at a time interval that is input into a box 43 of FIG. 2 (every five minutes in the example of FIG. 2).

Specifically, in the present embodiment, since the skill change is performed at multiple grades (since the escalation is performed), the skill change unit 18 performs the process of restoring the pre-change state of the skills or skill levels a plurality of times (three times from the first to third grades in the example of FIG. 9) in a stepwise manner. Namely, in the present embodiment, since the busy state is managed at multiple grades, upon resolving a predetermined grade of the busy state, the skill change unit 18 (FIG. 1) restores the pre-change state of the skills or skill levels of the operators, which were changed when determining the predetermined grade. In a case in which the predetermined grade is the first grade, the state at the pre-change grade represents a default state before the busy state.

Here, a specific example of defining a busy state (setting a criterion for a busy state) is described.

As described above, the state is a busy state as long as including one or more busy queues; and how to define a busy state is a design matter for an administrator or the like.

For example, assume that the first queue (first skill) and the second queue (second skill) exist. Also, assume that a first busy queue criterion exists for determining whether the first queue is a busy queue. Similarly, assume that a second busy queue criterion exists for determining whether the second queue is a busy queue.

In this case, as a definition of a busy state, the administrator or the like can select a desired setup (setup of a criterion for a busy state) from the following first to fourth setups.

The first setup is for determining that the current state is a busy state when only the first queue is a busy queue. Specifically, in the first setup, a state of satisfying the first busy queue criterion is a busy state.

The second setup is for determining that the current state is a busy state when only the second queue is a busy queue. Specifically, in the second setup, a state of satisfying the second busy queue criterion is a busy state.

The third setup is for determining that the current state is a busy state when all of the first and second queues are busy queues. Specifically, in the third setup, a state of satisfying all of the first and second busy queue criteria is a busy state.

The fourth setup is for determining that the current state is a busy state when any one of the first and second queues is a busy queue. Specifically, in the fourth setup, a state of satisfying any one of the first and second busy queue criteria is a busy state.

Here, the first and second queues are an illustrative example; and a busy state can be further defined by using three or more queues (three or more skills).

In this case, there exists a setup for determining whether the current state is a busy state by focusing on a predetermined single queue in relation to a plurality of queues (hereinafter referred to as “predetermined-single-queue setup”). The predetermined-single-queue setup can be realized by setting only a busy queue criterion for a predetermined queue. The first and second setups are an example of the predetermined-single-queue setup.

On the other hand, there exists a setup for determining whether the current state is a busy state by focusing on each of a plurality of queues, and comprehensively monitoring the plurality of queues (hereinafter referred to as “plural-queue setup”). The plural-queue setup can be realized by setting a plurality of busy queue criteria for each of the plurality of queues. The third and fourth setups are an example of the plural-queue setup.

For such a plural-queue setup, similar to the third setup, it is possible to employ a setup, in which a state of satisfying all of the plurality of busy queue criteria is a busy state (hereinafter referred to as “plural-queue AND setup”).

When such a plural-queue AND setup is desired, the administrator or the like checks a check box 75 on the screen of FIG. 9.

For the plural-queue setup, similar to the fourth setup, it is possible to employ a setup, in which a state of satisfying any one of the plurality of busy queue criteria is a busy queue (hereinafter referred to as “plural-queue OR setup”).

When such a plural-queue OR setup is desired, the administrator or the like checks a check box 76 on the screen of FIG. 9.

Although not illustrated, for the plural-queue setup, it is possible to employ a setup, in which a state of satisfying a desired M pieces (M is an integer value less than N) of N busy queue criteria (N is an integer value of at least 3) is a busy state.

Here, as described above, in the present embodiment, the busy state can be set at multiple grades.

The number of grades of the busy state is not limited in particular; however, for the purpose of illustration, setups of three grades from the first to third grades are described herein.

A busy state hierarchically transitions from the first to third grades in this order; however, since the condition (criterion) for transitioning from a predetermined grade to a next grade is an independent transition, an independent definition (criterion setup) is required.

Namely, as a definition (criterion setup) for each grade, a predetermined-single-queue setup may be employed, or a plural-queue setup alone may be employed. In this case, even if a predetermined-single-queue setup is employed for a certain level, it is not necessary in particular to employ the predetermined-single-queue setup for another level. Namely, a type and number of queues (skills) for monitoring whether a busy queue exists can be independently set for each grade.

Provided, however, for the purpose of illustration, in the example of FIG. 9, a predetermined-single-queue setup is employed for all of the first to third grades of the busy state.

The administrator or the like sets a condition for determining a busy state to be at the first grade (condition for performing a skill change at the first grade), by inputting predetermined items in an input area 77 on the screen of FIG. 9.

Specifically, since the predetermined-single-queue setup is employed in this example, only a busy queue criterion for a predetermined queue (predetermined skill) is input into the input area 77.

More specifically, new “entry” is set as a predetermined skill, and the waiting number of calls is 3 or more is set as a busy queue criterion for the new entry. Namely, in relation to the aforementioned criteria (A) to (C), FIG. 9 shows an example, in which “(B) the number of waiting calls having exceeded a certain number (threshold value)” is employed as a busy queue criterion, and “3” is input as a threshold value.

Similarly, the administrator or the like sets a condition for determining a busy state to be at the second grade (condition for performing a skill change at the second grade), by inputting predetermined items in the input area 78 on the screen of FIG. 9.

Specifically, “new entry” is set as a predetermined skill, and “the waiting number of calls is 5 or more” is set as a busy queue criterion for the new entry. Namely, FIG. 9 shows an example, in which “(B) the number of waiting calls having exceeded a certain number (threshold value)” is employed as a busy queue criterion, and “5” is input as a threshold value. Namely, the threshold value of the second grade is set to “5”, which is larger than “3” of the threshold value of the first grade.

The administrator or the like sets a condition for determining a busy state to be at the third grade (condition for performing a skill change at the third grade), by inputting predetermined items in an input area 79 on the screen of FIG. 9.

Specifically, “new entry” is set as a predetermined skill, and “the waiting number of calls is 7 or more” is set as a busy queue criterion for the new entry. Namely, FIG. 9 shows an example, in which “(B) the number of waiting calls having exceeded a certain number (threshold value)” is employed as a busy queue criterion, and “7” is input as a threshold value. Namely, the threshold value of the third grade is set to “7”, which is larger than “5” of the threshold value of the second grade.

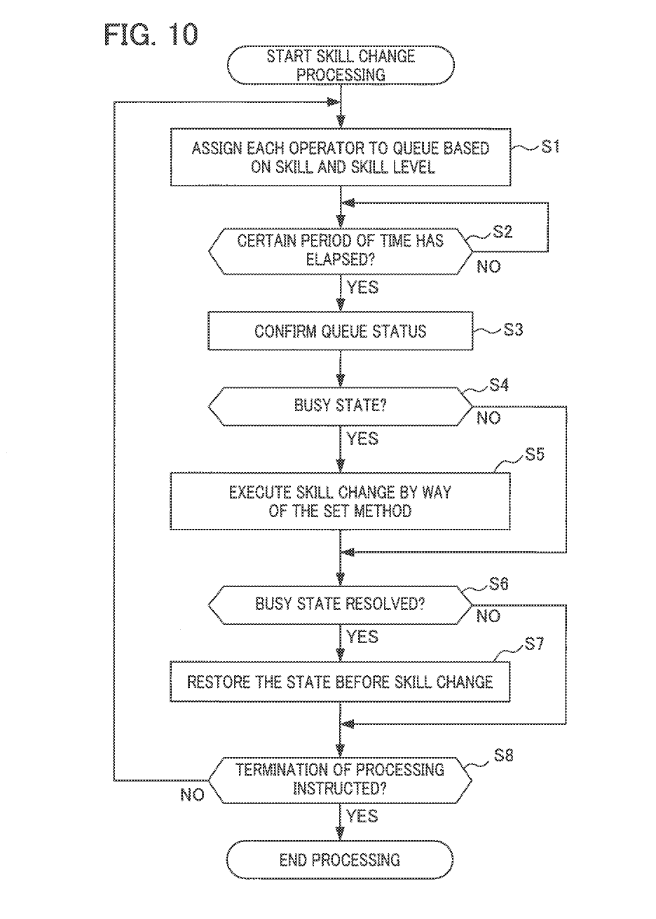

Referring now to FIG. 10, skill change processing, which is executed by the skill management apparatus 1 having the functional configuration of FIG. 1, is described.

FIG. 10 is a flowchart describing flow of the skill change processing, which is executed by the skill management apparatus 1 having the functional configuration of FIG. 1.

In Step S1, the queue assignment unit 14 assigns each operator to a queue, based on the skills and the skill levels.

In Step S2, the busyness determination unit 17 determines whether a certain period of time has elapsed.

In a case in which a certain period of time has not elapsed, the determination in Step S2 is NO, and the processing returns to Step S2. Namely, the determination processing of Step S2 is repeated until a certain period of time elapses, during which the skill change processing is held in a standby state. Namely, the certain period of time herein represents a time interval for the determination processing by the busyness determination unit 17, and is five minutes since “5” is input into the box 43 in the example of FIG. 2 described above.

When a certain period of time has elapsed, the determination in Step S2 is YES, and the processing advances to Step S3.

In Step S3, the queue status acquisition unit 16 confirms various states (queue status) of each of a plurality of queues.

In Step S4, the busyness determination unit 17 determines whether the current state is a busy state, based on the confirmation in Step S3.

Specifically, the busyness determination unit 17 determines whether the current state is a busy state, based on a criterion for the busy state (combination of one or more of the busy queue criteria).

In the present embodiment, since a busy state is determined at multiple grades (specifically, at three grades), if the immediately preceding state was a busy state, a determination is made as to whether the current state is a busy state, based on the criterion for the grade next to the immediately preceding grade (the criterion for the second grade, if the immediately preceding grade was the first grade).

In a case in which the current state is a busy state (if the immediately preceding state was a busy state, in the case of having transitioned to the next grade), the determination in Step S4 is YES, and the processing advances to Step S5.

In Step S5, the skill change unit 18 performs a skill change by way of a set method. As a result, the processing advances to Step S6.

Here, the set method refers to the skill change method, which is set on the screen of FIGS. 8 and 9 in the aforementioned example. Namely, a different method will be used depending on the grade of the busy state.

On the other hand, in a case in which the current state is not a busy state (if the immediately preceding state was a busy state, in the case of having not transitioned to the next grade), the determination in Step S4 is NO, and the processing advances to Step S6.

In Step S6, the busyness determination unit 17 determines whether the busy state is resolved, based on the confirmation in Step S3.

Specifically, the busyness determination unit 17 determines whether the busy state is resolved, based on a criterion for the busy state (combination of one or more of the busy queue criteria).

In the present embodiment, since a busy state is determined at multiple grades (specifically, at three grades), if the immediately preceding state was a busy state, a determination is made as to whether the busy state is resolved, based on a criterion for the current grade (the criterion for the first grade, if the immediately preceding grade was the first grade).

In a case in which the busy state is resolved (if the immediately preceding grade was the second or higher grade of the busy state, in the case of having transitioned to a previous level), the determination in Step S6 is YES, and the processing advances to Step S7.

In Step S7, the skill change unit 18 restores the pre-change state before the skill change.

Here, in a case in which the immediately preceding grade was the second or higher grade of the busy state, the state before the skill change is a state at the pre-change grade, which is a state at the next higher grade (the second grade if it was the third grade; or the first grade if it was the second grade).

Subsequently, the processing advances to Step S8.

On the other hand, in a case in which the busy state is not resolved (the case in which the immediately preceding state was a busy state, and is still remaining the same at the current grade), the determination in Step S6 is NO, and the processing advances to Step S8.

In Step S8, the skill change unit 18, etc. determine whether termination of the processing is instructed.

Here, an instruction to terminate the processing is not limited in particular; and for example, power shutdown or the like can be employed for such termination.

In a case in which termination of the processing is instructed (in a case in which power shutdown or the like is performed), the determination in Step S8 is YES, and the skill change processing is terminated.

On the other hand, in a case in which termination of the processing is not yet instructed, the determination in Step S8 is NO, the processing returns to Step 51, and the subsequent processing is repeated.

The present invention is not limited to the aforementioned embodiment; and modification, improvement, etc. in the range that can achieve the object of the present invention are included in the present invention.

Namely, the skill management apparatus, to which the present invention is applied, is not limited in particular to the aforementioned embodiment of FIG. 1, and can take various and diversified embodiments with features as follows.

The skill management apparatus, to which the present invention is applied, may include:

a queue management unit that manages a plurality of queues, each of which is associated with a predetermined single skill;

an operator management unit that manages one or more skills and skill levels of each of the one or more skills, for each of a plurality of operators who can provide the skills;

a queue assignment unit that assigns each of the plurality of operators to at least one of the plurality of queues, based on the skills and the skill levels;

a busyness determination unit that determines whether a current state is a busy state having one or more busy queues in the plurality of queues, based on a preset criterion; and a skill change unit that changes at least one of the skills and skill levels of at least part of the plurality of operators, to a designated one, when the current state is the busy state.

In the abovementioned embodiment, a touchscreen tablet is described as an example of the skill management apparatus 1, to which the present invention is applied; however, the present invention is not limited thereto in particular.

For example, the present invention can be applied to electronic devices having a display function in general. More specifically, for example, the present invention can be applied to a laptop personal computer, a television receiver, a video camera, a portable navigation device, a cellular telephone device, a portable gaming machine, etc.

The sequence of processing described above can be executed by hardware and/or software.

In other words, the functional configuration shown in FIG. 1 is merely an example, and is not limited thereto in particular. In other words, it is sufficient for the skill management apparatus 1 to include the functions which allow for executing the aforementioned sequence of processing as a whole; and what functional blocks should be used for implementing the functions is not particularly limited to the example shown in FIG. 1.

A single functional block may be configured by a single piece of hardware, a single piece of software, or a combination thereof.

In a case in which a sequence of processing is executed by software, a program configuring the software is installed from a network or a recording medium into a computer, etc.

The computer may be a computer incorporated into specialized hardware. The computer may be a computer such as a general-purpose personal computer capable of executing various functions by installing various programs.

The storage medium containing such a program is not only configured by the removable medium distributed separately from the device main body for supplying the program to the user, but is also configured by a storage medium or the like provided to the user in a state incorporated in the device main body in advance. The removable medium is configured by, for example, a magnetic disk (including a floppy disk), an optical disk, a magnetic optical disk, or the like. The optical disk is configured by, for example, a CD-ROM (Compact Disk-Read Only Memory), a DVD (Digital Versatile Disk), or the like. The magnetic optical disk is configured by an MD (Mini-Disk) or the like. The storage medium provided to the user in a state incorporated in the device main body in advance is configured by, for example, ROM, a hard disk or the like, in which the program is recorded.

In the present specification, the steps describing the program recorded in the storage medium include not only the processing executed in a time series following this order, but also processing executed in parallel or individually, which is not necessarily executed in a time series.

What is claimed is:

1. A skill management apparatus, comprising:
a queue management unit that manages a plurality of queues, each of which is associated with a predetermined single skill;
an operator management unit that manages one or more skills and skill levels of each of the one or more skills, for each of a plurality of operators who can provide the skills;
a queue assignment unit that assigns each of the plurality of operators to at least one of the plurality of queues, based on the skills and the skill levels;
a busyness determination unit that determines whether a current state is a busy state having one or more busy queues in the plurality of queues, based on a preset criterion; and
a skill change unit that changes at least one of the skills and the skill levels of at least part of the plurality of operators, to a designated one, when the current state is the busy state.

2. The skill management apparatus according to claim 1,
wherein the skill change unit changes at least one of the skills and the skill levels of a designated number of operators to be changed, in relation to the plurality of operators.

3. The skill management apparatus according to claim 2,
wherein the number of operators to be changed is set, based on the skill levels of the plurality of operators.

4. The skill management apparatus according to claim 1,
wherein the skill change unit changes the skills of operators who can provide multiple skills to a designated single skill, in relation to the plurality of operators.

5. The skill management apparatus according to any one of claims 1 to 4,
wherein, in a case in which the busy state is resolved, the skill change unit restores a pre-change state of the skills or the skill levels of the operators, which were changed when determining the busy state.

6. The skill management apparatus according to any one of claims 1 to 4,
wherein a busy queue determination unit further determines the busy state at a plurality of grades; and
wherein the skill change unit changes a method for changing at least one of the skills and skill levels, in accordance with the plurality of grades.

7. The skill management apparatus according to claim 6,
wherein, in a case in which a predetermined grade of the busy state is resolved, the skill change unit restores a pre-change state of the skills or the skill levels of the operators, which were changed when determining the predetermined grade.

8. A skill management method, which is performed by a skill management apparatus for managing skills of operators, the method comprising:
a queue managing step of managing a plurality of queues, each of which is associated with a predetermined single skill;
an operator managing step of managing one or more skills and skill levels of each of the one or more skills, for each of a plurality of operators who can provide the skills;
a queue assigning step of assigning each of the plurality of operators to at least one of the plurality of queues, based on the skills and the skill levels;
a busyness determining step of determining whether a current state is a busy state having one or more busy queues in the plurality of queues, based on a preset criterion; and
a skill changing step of changing at least one of the skills and the skill levels of at least part of the plurality of operators, to a designated one, when the current state is the busy state.

9. A program for causing a computer for managing skills of operators to execute control processing, comprising:
a queue managing step of managing a plurality of queues, each of which is associated with a predetermined single skill;
an operator managing step of managing one or more skills and skill levels of each of the one or more skills, for each of a plurality of operators who can provide the skills;
a queue assigning step of assigning each of the plurality of operators to at least one of the plurality of queues, based on the skills and the skill levels;
a busyness determining step of determining whether a current state is a busy state having one or more busy queues in the plurality of queues, based on a preset criterion; and
a skill changing step of changing at least one of the skills and the skill levels of at least part of the plurality of operators, to a designated one, when the current state is the busy state.
